(19) United States
(12) Patent Application Publication
(10) Pub. No.: US 2013/0286396 A1
(43) Pub. Date: Oct. 31, 2013

(54) INSPECTION DEVICE

(71) Applicant: OLYMPUS CORPORATION, Tokyo (JP)

(72) Inventor: Saori MATSUMOTO, Tokyo (JP)

(21) Appl. No.: 13/913,627

(22) Filed: Jun. 10, 2013

(30) Foreign Application Priority Data
Dec. 28, 2010 (JP) 2010-291967

(51) Int. Cl. G01J 3/50

(52) U.S. Cl. CPC G01J 3/50
USPC 356/402

(57) ABSTRACT

An inspection device for inspecting an object based on illumination light acting on the object, including a light detection unit that receives the illumination light acting on the object for inspection and is provided with photoelectric conversion units with different spectral sensitivity characteristics, an operating condition determining unit that determines operating conditions for the light detection unit, a measurement control unit that controls the light detection unit in accordance with the operating conditions, and a color estimation unit that estimates color of the object for inspection based on output from the light detection unit controlled in accordance with the operating conditions. The operating condition determining unit determines the operating conditions based on at least one of illumination information relating to the illumination light acting on the object for inspection and object information relating to the object for inspection.

### CROSS-REFERENCE TO RELATED APPLICATION

The present application is a Continuing Application based on International Application PCT/JP2011/007022 filed on Dec. 15, 2011, which, in turn, claims the priority from Japanese Patent Application No. 2010-291967 filed on Dec. 28, 2010, the entire disclosure of these earlier applications being herein incorporated by reference.

### TECHNICAL FIELD

The present invention relates to inspection devices in general, and in particular to microscopes and other such inspection devices for inspection of objects such as specimens.

### BACKGROUND ART

In recent years, devices such as microscopes and inspection apparatuses have been developed to measure characteristics, such as color, of specimens and other such objects to be inspected, using the results for image processing, diagnosis support, image inspection, and the like.

For example, among microscopes that analyze stained biological specimens, devices that obtain stable images of a specimen by measuring spectral characteristics of a plurality of portions of the specimen, estimating staining variation in the specimen, and performing image correction have been developed (for example, see JP2009014354A).

A device has also been proposed to efficiently capture wide-field, high-resolution digital images by dividing up the necessary observation area of the object for inspection or the object to be inspected, capturing images with a consecutively higher power objective lens while controlling the position of the object, and combining the divided images thus captured. There is a demand for such devices to consecutively image a plurality of slides that include objects to be inspected and to perform high-speed image processing. Since it is necessary to obtain spectroscopic data in a relatively short amount of time, spectrometry using diffraction grating or the like is not realistic. Therefore, a technique has been adopted to obtain simplified spectral characteristics in a relatively short amount of time by dividing the light path for a portion of light used in imaging and receiving the light with a multispectral sensor having a color filter or the like.

Color filters transmit particular wavelengths of visible light while blocking other wavelengths. Such color filters are structured in a variety of ways. For example, color filters may be made from colored glass, be coated with a layer that includes a dye, use what is known as an interference filter, or be able to control transmitted wavelengths electrically, as with a liquid crystal tunable filter. The multispectral sensor referred to here is a sensor that can receive light with a variety of different spectral characteristics.

While a multispectral sensor that uses color filters or the like is advantageous in terms of cost and size, differences in sensitivity occur between different color sensors that can be implemented with color filters. For example, with a color filter that uses dye, differences in sensitivity occur due to restrictions on usable dyes. On the other hand, filters using interference or filters that can electrically control wavelengths have few production restrictions on the wavelength band, but the acquired wavelength bands are often varied depending on use, such as when highly precise spectral analysis is desired in some wavelength ranges and not in others. As a result, differences in sensitivity occur between sensors of different colors. The amount of incident light also differs depending on the light source or object being measured.

With reference to FIGS. 8 through 10, details are now provided for an example of the above color filters that use dyes.

FIGS. 8(A) and 8(B) illustrate wavelengths along the horizontal axis and relative spectral sensitivity characteristics of each wavelength along the vertical axis. FIG. 8(A) illustrates the spectral sensitivity of a sensor using cut-type color filters, i.e. color filters that cause a sensor to detect light by cutting light at less than a predetermined wavelength and transmitting light with at least a predetermined wavelength. By contrast, FIG. 8(B) illustrates the spectral sensitivity characteristics of a sensor using band-type color filters, i.e. color filters that cause a sensor to detect light by only transmitting light in a predetermined wavelength band.

FIG. 8(A) shows curves representing spectral sensitivity characteristics of sensors corresponding to 15 filters constituting a multispectral sensor. For example, the sensor (sensor #1) corresponding to the curve starting farthest to the left has the highest spectral sensitivity near a wavelength of 530 nm and overall has a higher spectral sensitivity than the other curves. In other words, the sensor having these characteristics transmits a greater amount of light than the other sensors. On the other hand, the sensor (sensor #15) corresponding to the curve starting farthest to the right (near 720 nm) has a smooth peak near a wavelength of 740 nm and overall has a lower spectral sensitivity than the other sensors. In other words, the filter for sensor #15 transmits a smaller amount of light than the filters of the other sensors. Similarly, for the sensor using band-type color filters illustrated in FIG. 8(B), the spectral sensitivity of the filters constituting the sensor differs over a variety of wavelength bands.

In addition to this difference in the amount of light entering the sensor for each wavelength due to the characteristics of the color filter, the characteristics of the light itself that enters the color filter differ depending on the type of light source used for the microscope. Light sources used in microscopes include, for example, Light Emitting Diode (LED) light sources and halogen light sources. Depending on use, a halogen light source may be used along with a color conversion filter or a color temperature conversion filter (for example, an LBD filter). FIG. 9 illustrates the spectral characteristics of different light sources. An LED light source (white) has a high peak near a wavelength of 460 nm and a relatively low peak near a wavelength of 560 nm. A halogen light source has no peak at visible wavelengths of light, and the intensity increases as the wavelength increases. On the other hand, for a halogen light source equipped with an infrared cut filter, the curve representing spectral sensitivity characteristics has no particularly high peak, as does an LED light source, and has a relatively stable intensity at visible wavelengths of light. In this way, in accordance with the type of light source, the intensity of light entering the sensor differs greatly.

Furthermore, the sensor output varies by wavelength and light source for the sensors constituting a multispectral sensor. This point is described with reference to FIG. 10. FIG. 10 illustrates the output values for sensor #1 through sensor #15 for the above three types of light sources, namely an LED light source, a halogen light source, and a halogen light source equipped with an infrared cut filter. The vertical axis represents the relative value of sensor output when the maximum output is one. The numbers along the horizontal axis correspond to the numbers of the sensors. As shown in FIG. 8(A), as the sensor number is larger, the sensor has a peak at a longer wavelength.

For each light source, sensor #1 has the maximum output value of one. For sensors #2 through #15, the sensor output decreases relative to an increase in the wavelength of detected light. The tendency towards a lower value is smoothest when using a halogen light source with a color conversion filter. When using an LED light source and a halogen light source, the sensor output sharply decreases at progressively longer wavelengths as compared to when using a halogen light source with a color conversion filter. The characteristics of light entering the multispectral sensor thus vary depending on the type of light source as well.

In addition to the above-described characteristics of color filters constituting a multispectral sensor, characteristics of the sensors, and characteristics of the light source producing the light entering the multispectral sensor, other factors that also change the light entering the sensors are the conditions that can be assumed during microscope observation, such as the objective lens and the depth of color of the object. Accordingly, sensors constituting a multispectral sensor require an extremely wide dynamic range.

Sensors that detect the amount of incoming light by integrating the photoelectric current produced in a photodiode (i.e. detection by storage and integration) have been used, such as Complementary Metal Oxide Semiconductors (CMOS) and Charge Coupled Devices (CCD). Accordingly, if a large difference in the amount of light entering the photodiode of each sensor occurs due to differences in the characteristics of light entering the sensors constituting a multispectral sensor, as described above, then an extremely large dynamic range is required for the photodiodes and their readout circuits.

When the sensors constituting a multispectral sensor are controlled to have the same integration time, the dynamic range of the sensors is insufficient, making it necessary to take measures such as integrating multiple times while changing the brightness, measuring multiple times with different gains, and canceling the flicker of the light source. More time is thus required for measurement, thereby preventing measurement from becoming high speed.

To address this problem, approaches involving the sensors include providing the sensors that constitute the multispectral sensor with different opening areas (for example, see JP2004317132A) or varying the gain when reading out sensor data in accordance with the sensitivity of each sensor (for example, see JP2005308747A and JP2007010337A). Such hardware-based approaches, however, make the sensor circuits complex. Furthermore, when a variety of light sources are used to measure objects of different colors, control patterns corresponding to all possible combinations must be embedded into the hardware at the time of design. The hardware configuration thus becomes elaborate, leading to the problem of increased costs.

### SUMMARY OF INVENTION

An inspection device according to the present invention is for inspecting an object based on illumination light acting on the object, the inspection device comprising: a light detection unit configured to receive the illumination light acting on the object for inspection and provided with a plurality of photoelectric conversion units with different spectral sensitivity characteristics; an operating condition determining unit configured to determine operating conditions for the light detection unit; a measurement control unit configured to control the light detection unit in accordance with the operating conditions; and a color estimation unit configured to perform color estimation processing based on output from the light detection unit controlled in accordance with the operating conditions, wherein the operating condition determining unit determines the operating conditions based on at least one of illumination information relating to the illumination light acting on the object for inspection and object information relating to the object for inspection.

The inspection device according to the present invention preferably further comprises a setting storage unit. The operating condition determining unit is preferably further configured to acquire the illumination information from information stored in the setting storage unit.

In the inspection device according to the present invention, the operating condition determining unit is preferably further configured to acquire the illumination information by determining a type of illumination based on output of the light detection unit controlled in accordance with predetermined operating conditions.

In the inspection device according to the present invention, the operating condition determining unit is preferably further configured to acquire the object information by determining a type of the object for inspection based on output of the light detection unit controlled in accordance with predetermined operating conditions.

The inspection device according to the present invention preferably further comprises a virtual slide generation unit configured to generate a virtual slide by moving the light detection unit and the object for inspection relative to each other and acquiring results of inspection at a plurality of locations on the object for inspection.

In the inspection device according to the present invention, the operating condition determining unit is preferably further configured to acquire the object information based on output of the light detection unit controlled in accordance with operating conditions based on the acquired illumination information, and output of the light detection unit controlled in accordance with predetermined operating conditions.

In the inspection device according to the present invention, the operating condition determining unit preferably includes a read unit and is preferably further configured to acquire the object information by the read unit reading the object information from an external information storage unit.

In the inspection device according to the present invention, the operating condition determining unit preferably determines the operating conditions by determining at least one of the following: an integration time, a number of integration operations, a time interval between integration operations, and a number of accumulations for output of the light detection unit, and a gain for each of the plurality of photoelectric conversion units in the light detection unit.

In the inspection device according to the present invention, the operating condition determining unit preferably determines the operating conditions by determining one or more photoelectric conversion units to use among the photoelectric conversion units in the light detection unit.

In the inspection device according to the present invention, the operating condition determining unit preferably determines the operating conditions by determining that integration operations by the light detection unit are to be performed a plurality of times in order to extend a dynamic range of the light detection unit and by determining a time interval between consecutive integration operations, an integration time for the output from the light detection unit upon each integration operation, and a gain for each of the plurality of photoelectric conversion units.

In the inspection device according to the present invention, the color estimation unit preferably performs the color estimation processing by performing at least one of detailed identification and spectral estimation of a color of the object for inspection.

### BRIEF DESCRIPTION OF DRAWINGS

The present invention will be further described below with reference to the accompanying drawings, wherein:

FIG. 1 is a block diagram illustrating the configuration of a microscope apparatus according to an embodiment of the present invention;

FIG. 2 is a flowchart illustrating an example of a method by which an operating condition determining unit acquires illumination information;

FIG. 3 is a flowchart illustrating an example of a method by which the operating condition determining unit acquires specimen information;

FIG. 4 is a flowchart illustrating operations by the microscope apparatus according to an embodiment of the present invention;

FIG. 5 schematically illustrates the configuration of a microscope system including the microscope apparatus according to an embodiment of the present invention;

FIG. 6 is a block diagram schematically illustrating the optical configuration of the microscope system in FIG. 5;

FIG. 7 is a flowchart illustrating schematic operations of the microscope system in FIG. 5;

FIG. 8(A) shows curves representing spectral sensitivity characteristics of filters constituting a multispectral sensor;

FIG. 8(B) shows curves representing spectral sensitivity characteristics of filters constituting a multispectral sensor;

FIG. 9 illustrates the spectral characteristics of different light sources; and

FIG. 10 illustrates output values of sensors for various light sources.

### DESCRIPTION OF EMBODIMENTS

An embodiment of an inspection device according to the present invention will be described in detail with reference to the drawings.

An inspection device according to the present invention can, for example, be used for purposes such as detecting a particular color and improving the color reproducibility upon imaging (development). In the present embodiment, an example is described of a microscope apparatus that measures an object for inspection. The object for inspection is a block specimen obtained by organ harvesting or a pathological specimen obtained by needle biopsy. Therefore, in the following explanation, the object for inspection that is targeted for measurement is referred to as a specimen, and object information relating to the object for inspection is referred to as specimen information. Since a thinly sliced specimen is nearly clear and colorless, hardly absorbing or scattering light, the specimen is typically stained with dye before observation.

Staining of a biological tissue specimen consists of fixing dye, via a chemical reaction, to biological tissue that inherently has individual differences. Therefore, it is difficult to obtain uniform results, and staining exhibits variation between specimens. Staining variation can be reduced to some degree within a facility by employing a staining technician with specialized skills, but the problem of staining variation between facilities remains unresolved.

Staining variation leads to the risk of crucial evidence being overlooked. Furthermore, when light passing through the stained specimen is detected, measured, converted into an image and processed, staining variation might adversely affect the accuracy of image processing. For example, even if it is known that a certain lesion exhibits a particular color, it may become difficult to extract an image region corresponding to the lesion automatically from an observed image generated by imaging the specimen.

Thus, before detecting and measuring the light that passes through (acts on) the stained specimen targeted for measurement, the microscope apparatus of the present embodiment determines operating conditions of a light detection unit that detects and measures light and estimates color of the specimen based on output from the light detection unit. Adjusting the operating conditions of the light detection unit allows for optimization of measurement conditions for the specimen.

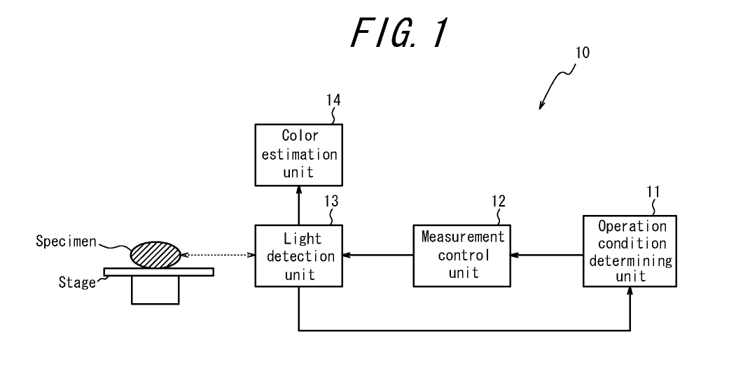

FIG. 1 is a block diagram schematically illustrating the main parts of a microscope apparatus of the present embodiment. The microscope apparatus 10 of the present embodiment is provided with an operation condition determining unit 11, a measurement control unit 12, a light detection unit 13, and a color estimation unit 14. While not illustrated, the microscope apparatus 10 is, for example, also provided with an LED, halogen lamp, or the like as a light source.

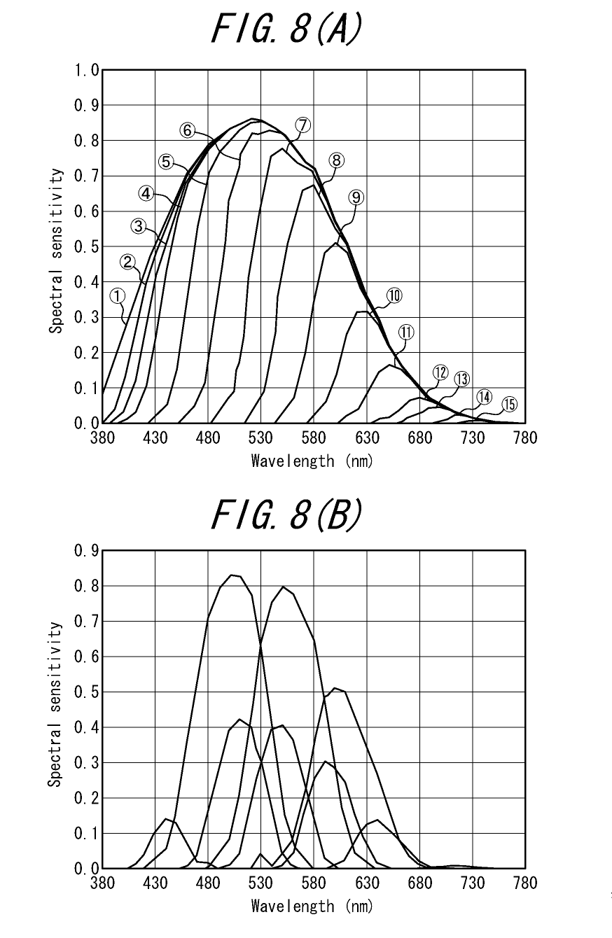

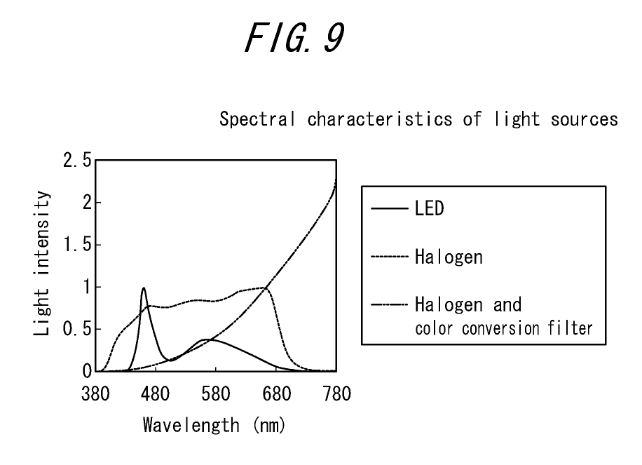

The light detection unit 13 receives the illumination light acting on the specimen and is provided with a plurality of photoelectric conversion units with different spectral sensitivity characteristics. In this embodiment, the light detection unit 13 is provided with a multispectral sensor having color filters with characteristics like those shown in FIG. 8(A). The light detection unit 13 detects light (measurement light) that is emitted from the light source and that passes through the specimen targeted for measurement.

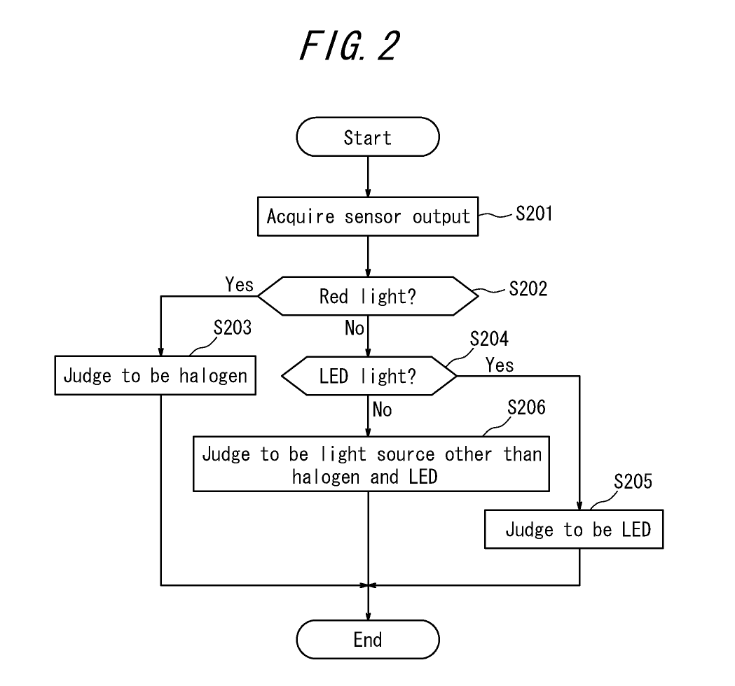

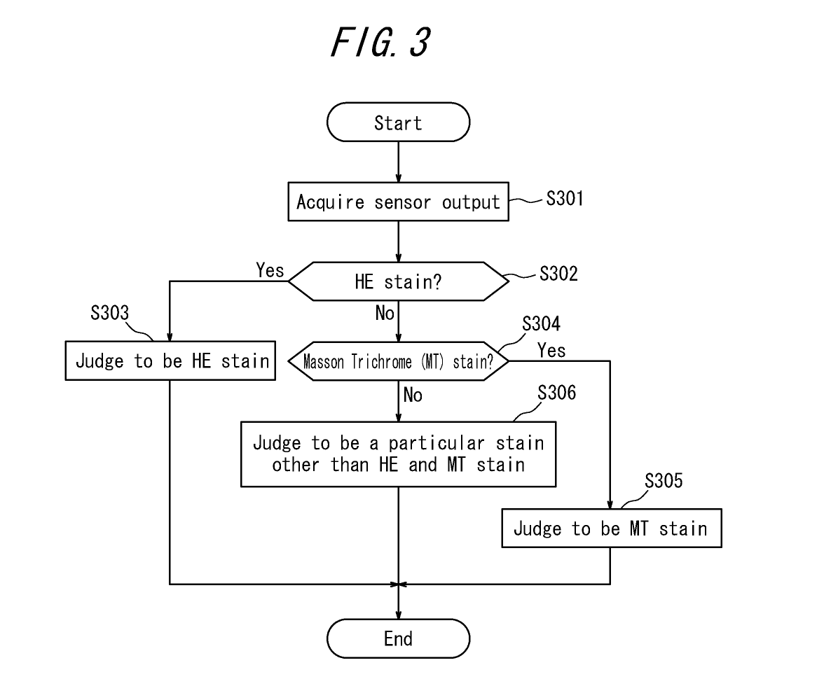

The operation condition determining unit 11 determines operating conditions for the light detection unit 13. In particular, the operation condition determining unit 11 determines operating conditions for the light detection unit 13 based on at least one of illumination information relating to the illumination light acting on the specimen and specimen information relating to the specimen. Furthermore, the operation condition determining unit 11 acquires the illumination information by determining the type of illumination based on output (sensor output) of the light detection unit 13 controlled in accordance with predetermined operating conditions (hereinafter referred to as light detection preliminary operations). When acquiring the illumination information, the operation condition determining unit 11 judges the type of light source (illumination) that shines light on the specimen in accordance with the method described below with reference to FIG. 2. Furthermore, when acquiring the specimen information, the operation condition determining unit 11 judges the type of stain of the specimen in accordance with the method described below with reference to FIG. 3.

The operation condition determining unit 11 not only acquires the illumination information and the specimen information in accordance with the methods described below with reference to FIGS. 2 and 3, but can also determine the operating conditions of the light detection unit 13 by receiving input through a user interface and acquiring the illumination information and specimen information based on the input. Information can be input manually in this case by using a keyboard that constitutes an input unit.

In this case, the operation condition determining unit 11 preferably includes a read unit and acquires the specimen information by the read unit reading from an external information storage unit. The read unit may be constituted by an automatic reading type barcode reader. When the specimen is set at a predetermined location, the automatic reading type barcode reader automatically reads a barcode in which specimen information is embedded. The specimen information can thus be acquired in a fully automated manner, without requiring manual input, thereby offering the advantages of easier and faster operation. While specimen information may be acquired directly from a barcode, specimen information may alternatively be acquired via a communication means such as the Internet in accordance with the information read by the barcode reader. Specimen information for example includes information on the facility where the specimen was prepared, the staining method for the specimen, the organ type of the specimen, and the thickness of the specimen. Other information, such as the staining dye for the specimen, image information, and the like may also be included.

FIG. 2 is a flowchart illustrating an example of a method by which the operation condition determining unit 11 acquires the illumination information. The operation condition determining unit 11 includes predetermined standard illumination information and acquires the illumination information based on a comparison of sensor output from the light detection unit 13 with the predetermined standard illumination information. Here, the standard illumination information is, for example, composed of reference values representing spectral characteristics of light sources with which the microscope can be equipped, such as a halogen light source or an LED light source. Specifically, the standard illumination information for a halogen light source may be a reference value for the amount of red light (wavelength of approximately 620 nm to 750 nm) or of infrared light (wavelength of approximately 700 nm to 1 mm), and the standard illumination information for an LED light source may be a reference value for the amount of light near a wavelength of 460 nm, at which the spectrum of white LED light peaks. These reference values for the amount of light may be absolute values or may be relative values, such as the ratio of the above red light or infrared light to a predetermined color (such as 500 nm to 600 nm).

The operation condition determining unit 11 acquires the sensor output for the light (illumination light) emitted from the light source detected by the light detection unit 13 operating in accordance with the predetermined light detection preliminary operations (step S201). For example, the light detection preliminary operations are operations to detect the sensor output for the light passing through a slide glass for mounting specimens (not including a specimen) that is set on the stage of the microscope apparatus 10, i.e. for illumination light that does not act on a specimen. The operation condition determining unit 11 analyzes the acquired sensor output and judges whether red light is present (step S202). This judgment is made based on the output from the sensor, among the plurality of sensors constituting the multispectral sensor, provided for detecting light in the wavelength range of red light. For example, the operation condition determining unit 11 judges whether red light is present by judging whether the sensor output from the sensor that detects light passing through a color filter with spectral sensitivity characteristics like those of the plot line starting thirteenth from the left among the plot lines illustrated in FIG. 8(A) (the plot line for sensor #13) is at least a predetermined value. Note that in step S202, the operation condition determining unit 11 may judge whether infrared light instead of red light is present. Furthermore, while the presence of light in a predetermined wavelength band is detected in the present embodiment based on sensor output for the predetermined wavelength band, it may alternatively be judged whether the ratio of sensor output for a predetermined wavelength band to sensor output for a reference wavelength band (for example 500 nm to 600 nm) is at least a predetermined value.

When judging that red light is present in step S202, the operation condition determining unit 11 judges that the light source is a halogen light source (step S202: Yes, step S203). On the other hand, when judging in step S202 that no red light is present, the operation condition determining unit 11 judges whether LED light (in particular, white LED light) is present (step S202: No, step S204). The judgment is made, for example, based on whether the amount of light near a wavelength of 460 nm, at which the spectrum of white LED light peaks, is at least a predetermined value. For example, the operation condition determining unit 11 divides the value detected by the sensor that detects light passing through a color filter with transmission characteristics like those of the plot line starting fifth from the left (the plot line for sensor #5) by the value detected by the sensor that detects light passing through a color filter with transmission characteristics like those of the plot line starting sixth from the left (the plot line for sensor #6) among the plot lines illustrated in FIG. 8(A) and judges whether the quotient is larger than a predetermined value.

When judging that LED light is present in step S204, the operation condition determining unit 11 judges that the light source is an LED light source (step S204: Yes, step S205). On the other hand, when judging that no LED light is present in step S204, the operation condition determining unit 11 judges that the light source is a source other than a halogen light source or an LED light source (step S204: Yes, S206). While a judgment is made regarding a halogen light source in step S202 and regarding an LED light source in step S204 in the present embodiment, the light sources for which judgments are made in these steps are not limited to a halogen light source and an LED light source. Rather, a judgment may be made for any light source that can be mounted on the microscope apparatus 10. In this way, the operation condition determining unit 11 acquires the illumination information by determining the type of illumination (light source) based on the output of the light detection unit 13 and can therefore determine optimal operating conditions for measurement of the specimen in accordance with the type of illumination.

FIG. 3 is a flowchart illustrating an example of a method by which the operation condition determining unit 11 acquires the specimen information. The operation condition determining unit 11 acquires the specimen information by identifying the type of specimen based on output of the light detection unit 13 controlled in accordance with predetermined operating conditions. The operation condition determining unit 11 acquires sensor output from the multispectral sensor of the light detection unit 13 for the illumination light (measurement light) emitted from the light source and acting on (passing through) the specimen (step S301). The operation condition determining unit 11 then judges whether the stain of the specimen targeted for measurement is a Hematoxylin and Eosin (HE) stain (step S302). For example, this judgment is made by comparing the acquired sensor output with HE stain reference data stored in a database (not illustrated) in advance and judging whether the sensor output matches the HE stain reference data.

When the sensor output matches the HE stain reference data, the operation condition determining unit 11 judges that the specimen stain is an HE stain (step S302: Yes, step S303). On the other hand, when judging that the sensor output does not match the HE stain reference data, the operation condition determining unit 11 judges that the specimen stain is a Masson's Trichrome (MT) stain (step S304). As in step S302, the judgment is made by comparing the sensor output with MT stain reference data stored in a database (not illustrated) in advance and judging whether the values match.

When judging that the sensor output matches the MT stain reference data, the operation condition determining unit 11 judges that the specimen stain is an MT stain (step S304: Yes, step S305). On the other hand, when judging in step S304 that the specimen stain is not an MT stain, the operation condition determining unit 11 judges that the specimen stain is a particular stain other than an HE stain and an MT stain (step S304: No, step S306).

Note that the specimen is stained a greater number of colors with an MT stain than with an HE stain, thus requiring more detailed measurement. Furthermore, depending on use, the operation condition determining unit 11 may also be configured to determine whether the specimen stain is another particular stain, such as a Giemsa stain. Furthermore, the operation condition determining unit 11 is not limited to HE stains, which are a standard stain in pathological examinations, nor to MT stains, which are also a particular stain, but may also be configured to make judgments regarding immunostains.

The measurement control unit 12 controls the light detection unit 13 in accordance with the operating conditions determined by the operation condition determining unit 11. Table 1 lists examples of operating conditions.

TABLE 1

| | Illumination Information | | | | | | | | |
|---|---|---|---|---|---|---|---|---|---|
| | LED Light Source | | | Halogen Light Source | | | Other | | |
| | Specimen Information | | | | | | | | |
| | HE stain | MT stain | Other | HE stain | MT stain | Other | HE stain | MT stain | Other |
| Measurement | Omit 2, 4, | Omit 5, 7, | 1 to 12 | Omit 2, 4, | Omit 13, | 1 to 15 | Omit 2, 4, | Omit 13, | 1 to 15 |
| Channels | 6, 8, 10, | 13, 14, 15 | | 6, 8, 10, | 14, 15 | | 6, 8, 10, | 14, 15 | |
| | 12, 13, | | | 12 | | | 12 | | |
| | 14, 15 | | | | | | | | |

| | | | |
|---|---|---|---|
| Number of | 10 | 1 | 3 |
| Accumulations | | | |
| Flicker Canceling | Yes | No | Yes |
| Sensor Integration | Setting 1 (three times while | Setting 2 (five times while | Setting 2 (five times while |
| Time | changing the integration time) | changing the integration time) | changing the integration time) |

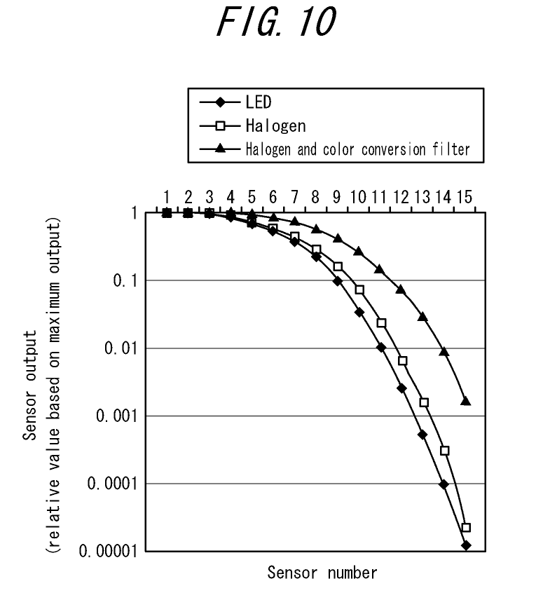

As shown in Table 1, for each light source (illumination information) and staining method (specimen information), the operation condition determining unit 11 stores settings for the measurement channels (photoelectric conversion units) used for measurement, the number of accumulations, whether flickering is canceled, the sensor integration time, the number of integration operations, and the like in advance. The operation condition determining unit 11 also stores a setting in advance for the time interval between operations when integration operations are performed multiple times. Furthermore, the operation condition determining unit 11 stores a variety of gains for the sensor output of each sensor in advance. Among the sensor output from the plurality of sensors (photoelectric conversion units) in the multispectral sensor constituting the light detection unit 13, the measurement channels refer to the sensors used for measurement of the specimen. The numbers of the measurement channels correspond to the numbers of the sensors for detecting light in the wavelength regions of the colors used in the specified staining method and are the same as the sensor numbers in FIG. 10.

The number of accumulations refers, for example, to the number of measurements in the case that the average value of multiple measurements is used. Increasing the number of accumulations both achieves high measurement accuracy and allows for measurement when the object is dark. Flicker cancelling includes, for example, PWM control to remove of the effects of flickering for an LED light source. The operation condition determining unit 11 determines the operating conditions by determining at least one of the following: the integration time, the number of integration operations, the time interval for integration operations, and the number of accumulations for output of the light detection unit 13, and the gain for each of the photoelectric conversion units in the light detection unit 13. In this way, the microscope apparatus of the present embodiment has a simple, low-cost structure yet can measure a specimen by determining conditions that are optimal for the illumination or the specimen.

Furthermore, the microscope can extend the dynamic range by performing multiple measurements while changing the sensor integration time. In this case, the operation condition determining unit 11 determines the time interval between consecutive integration operations, the integration time for the sensor output from the light detection unit 13 upon each integration operation, and the gain for each of the plurality of photoelectric conversion units. In this way, the microscope apparatus of the present embodiment can measure a specimen rapidly and with a high degree of precision.

Based on the illumination information and the specimen information acquired by the operation condition determining unit 11, the measurement control unit 12 controls the measurement channels of the light detection unit 13, the number of accumulations of the sensor output by the measurement channels, whether flickering is canceled, and the sensor integration time.

The color estimation unit 14 performs color estimation processing based on the sensor output acquired from the light detection unit 13 controlled in accordance with the operating conditions. Color estimation processing may be at least one of detailed identification and spectral estimation of the color of the specimen and estimation of the dye amount in the specimen. Performing color estimation processing can improve the visibility of the specimen image, i.e. the result of inspection obtained from the light detection unit 13, and can also improve the accuracy of processing to identify the specimen image. The color estimation processing may be performed by a well-known method such as Wiener estimation.

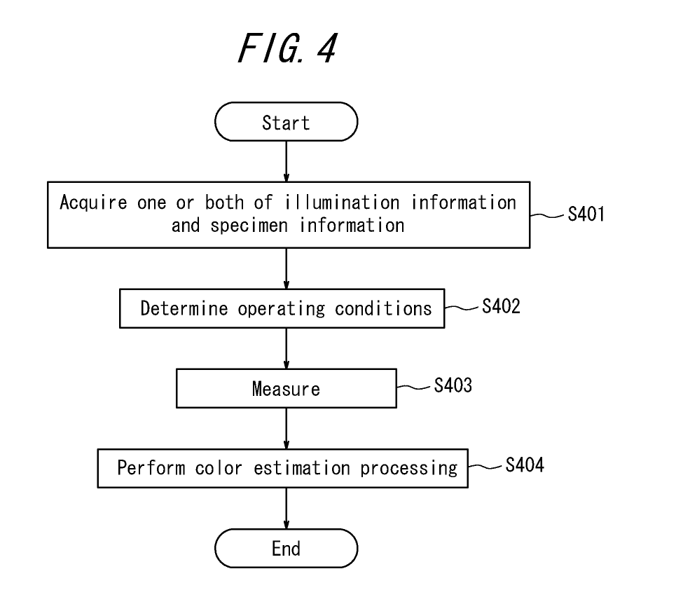

FIG. 4 is a flowchart illustrating operations by the microscope apparatus according to the present embodiment. The microscope apparatus 10 acquires one or both of the illumination information and the specimen information via the operation condition determining unit 11 (step S401). The operation condition determining unit 11 then determines the operating conditions corresponding to the acquired information (step S402). Next, the measurement control unit 12 performs measurement by controlling the light detection unit 13 in accordance with the determined operating conditions and acquires sensor output (step S403). The color estimation unit 14 performs color estimation processing based on the sensor output from the light detection unit 13 (step S404).

In this way, by including the operation condition determining unit 11, the microscope apparatus of the present embodiment can change the operating conditions of the light detection unit 13 in accordance with the type and characteristics of the illumination and the specimen and can therefore always measure specimens under optimal conditions.

Furthermore, when acquiring the illumination information as described with reference to FIG. 2, the operation condition determining unit 11 can determine the operating conditions for the light detection unit 13 by receiving input through a user interface and acquiring the illumination information as information that was input, such as the type of light source. In this case, the time until measurement of the specimen can be shortened as compared to when the illumination information is acquired based on measurement, as shown in FIG. 2.

Furthermore, the operation condition determining unit 11 can also acquire the illumination information as setting information stored in a setting storage unit or the like not shown in the figures. The setting storage unit is, for example, coordinated with an illumination selector switch attached to the microscope apparatus of the present embodiment. By referring to the setting storage unit, the operation condition determining unit 11 acquires illumination information on the type of light source, for example (such as an LED light source or halogen light source). In this case, the operation condition determining unit 11 does not measure the illumination light in order to acquire the illumination information, and therefore can rapidly determine the operating conditions for the light detection unit 13 and measure the specimen. When the illumination is from a halogen light source, the operation condition determining unit 11 acquires illumination information regarding the presence of a color conversion filter, for example from information on a filter on/off switch stored in the setting storage unit or the like. The illumination information is then categorized into one of the following cases, for example: (1) LED light source with frequency control or Pulse Width Modulation (PWM) control, (2) LED light source with neither frequency control nor PWM control, (3) halogen light source with a color conversion filter, and (4) halogen light source only. When acquiring illumination information such as (1), the operation condition determining unit 11 judges that flicker canceling is necessary and determines the operating conditions for the light detection unit 13 based on the judgment result.

Furthermore, instead of acquiring the illumination information by the method described with reference to FIG. 2, the operation condition determining unit 11 may include preset illumination information and determine the operating conditions for the light detection unit 13 based on the preset illumination information.

When acquiring the specimen information as described with reference to FIG. 3, the operation condition determining unit 11 can also read a barcode or the like attached to the preparation including the specimen and acquire specimen information embedded in the barcode. The time for measurement of the specimen information can thus be shortened, thereby allowing for rapid measurement of the specimen.

Furthermore, the operation condition determining unit 11 can acquire the specimen information based on (i) sensor output of the light detection unit 13 controlled in accordance with operating conditions based on illumination information acquired by the method described with reference to FIG. 2 or the like and (ii) sensor output of the light detection unit 13 acquired in accordance with predetermined operating conditions. In other words, the operation condition determining unit 11 can acquire the specimen information using already acquired illumination information. In this way, the microscope apparatus of the present embodiment can measure a specimen based on illumination information and on specimen information that is acquired quickly and to a high degree of precision based on the illumination information.

In this case, the operation condition determining unit 11 measures the sensor output from the light detection unit 13 for light passing through the specimen in accordance with operating conditions determined based on the acquired illumination information. The operation condition determining unit 11 then estimates the spectral transmittance of the specimen based on this sensor output and of the sensor output at the time the illumination information was acquired. The operation condition determining unit 11 thus identifies the stain applied to the specimen. Note that as described with reference to FIG. 3, the operation condition determining unit 11 can identify the stain by a comparison with reference data on an HE stain, an MT stain, or the like stored in advance in a database.

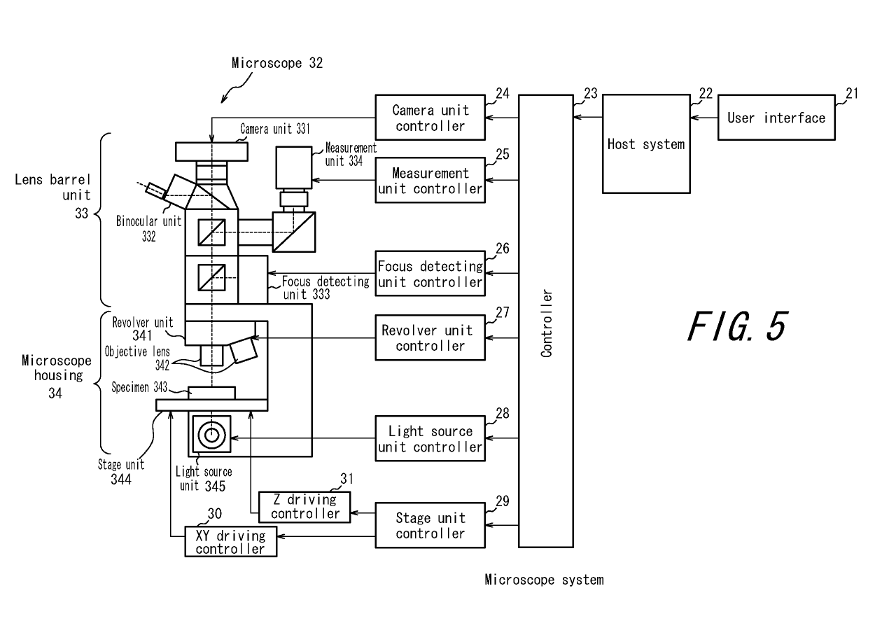

FIG. 5 schematically illustrates a specific configuration of a microscope system provided with the microscope apparatus of the present embodiment. The microscope system includes a user interface 21, a host system 22, a controller 23, a camera unit controller 24, a measurement unit controller 25, a focus detecting unit controller 26, a revolver unit controller 27, a light source unit controller 28, a stage unit controller 29, an XY driving controller 30, a Z driving controller 31, and a microscope 32. The host system 22 is, for example, a PC and corresponds to the operation condition determining unit 11 and the color estimation unit 14. The controller 23 corresponds to the measurement control unit 12.

The microscope 32 includes a microscope housing 34 having a reversed square C shape when viewed from the side and a lens barrel unit 33 placed on the top of the microscope housing 34. The lens barrel unit 33 includes a camera unit 331, a binocular unit 332, a focus detecting unit 333, and a measurement unit 334. The camera unit 331 is provided with image pickup devices such as CCD and CMOS that image a specimen within the field of view of an objective lens 342. The camera unit 331 images the specimen and outputs the specimen image to the host system 22. The binocular unit 332 enables visual observation of the specimen 343 by guiding observation light. The measurement unit 334 acquires spectral information on the specimen 343 and outputs the information to the host system 22.

The microscope housing 34 includes a revolver unit 341 holding the objective lens 342, a stage unit 344 on which the specimen 343 is mounted, and a light source unit 345 attached at the back side of the bottom of the microscope housing 34.

The revolver of the revolver unit 341 is rotatable with respect to the microscope housing 34 and positions the objective lens 342 above the specimen 343. The objective lens 342 is attached to the revolver with other objective lenses of different magnification level (magnification of observation) and can be exchanged with these objective lenses. The objective lens 342 that is inserted in the light path of the observation light for observation of the specimen 343 can be selectively switched by rotating the revolver.

The stage of the stage unit 344 is configured to move freely in the XYZ direction, where the optical axis direction of the objective lens 342 is the Z direction, and the plane perpendicular to the Z direction is the XY plane. Specifically, the stage can be moved freely in the XY plane by a motor (not illustrated), the driving of which is controlled by the XY driving controller 30. The XY driving controller 30 detects a predetermined origin position of the stage in the XY plane with an origin sensor (not illustrated) for XY positioning and controls the driving amount of the motor with reference to the origin position in order to move the observation field of view for the specimen.

Also, the stage can be moved freely in the Z direction by a motor (not illustrated), the driving of which is controlled by the Z driving controller 31. The Z driving controller 31 detects a predetermined origin position of the stage in the Z direction with an origin sensor (not illustrated) for Z positioning and controls the driving amount of the motor with reference to the origin position in order to move the specimen into focus at any Z position within a predetermined height range.

The controller 23 performs overall control of the units constituting the microscope 32 based on control by the host system 22. For example, the controller 23 adjusts the units of the microscope 32 in association with observation of the specimen 343. Such adjustments include rotating the revolver to switch the objective lens 342 positioned in the light path of the observation light, controlling the light source and switching various optical devices in accordance with factors such as the magnification level of the switched objective lens 342, and instructing the XY driving controller 30 and the Z driving controller 31 to move the stage. The controller 23 also notifies the host system 22 of the status of the units as necessary.

The controller 23 also implements autofocus to focus automatically on the specimen 343 by controlling the focus detecting unit 333 to acquire the focusing status of the microscope 32 and providing stage movement instructions to the Z driving controller 31 in response to the acquired status.

Furthermore, based on the control of the host system 22, the controller 23 controls imaging operations of the camera by driving the camera unit 331, for example by switching automatic gain control functionality on and off, setting the gain, switching automatic exposure control on and off, and setting the exposure time of the camera unit 331. The controller 23 also controls the measurement field of view, the measurement locations, the number of measurement locations, the number of accumulations when measuring, the number of channels of the multispectral sensor, the filter settings, and the like for the measurement unit 334 to acquire spectral data.

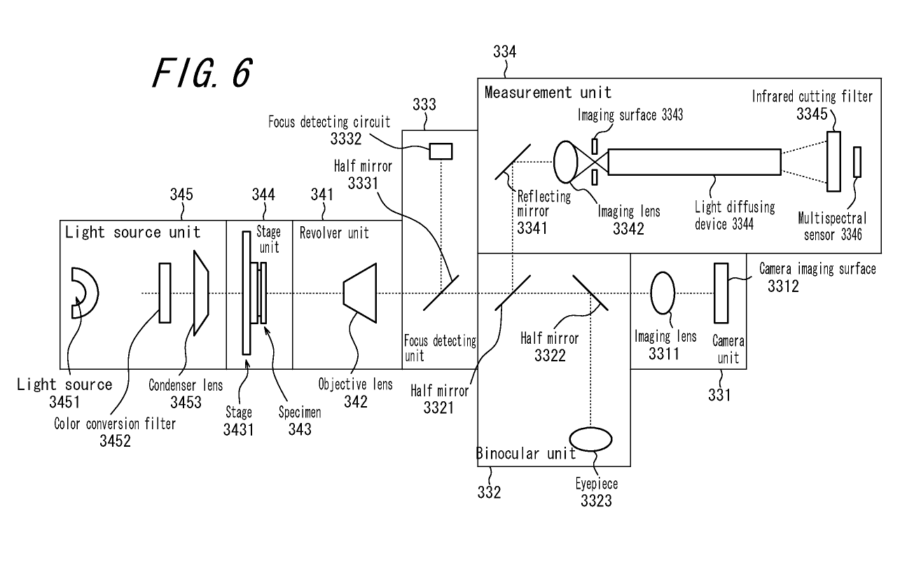

FIG. 6 is a block diagram schematically illustrating the optical configuration of the microscope system. The illumination light emitted from the light source 3451 of the light source unit 345 passes through a color conversion filter 3452 and a condenser lens 3453 and illuminates the specimen 343. The light passing through the specimen 343 then enters the objective lens 342.

The light passing through the objective lens 342 is divided by a half mirror 3331. One portion is guided into a focus detecting circuit 3332, and the other portion is guided into the binocular unit 332. The light guided into the binocular unit 332 is directed to the eyepiece 3323 by half mirrors 3321 and 3322 so that the image for inspection (specimen image) of the specimen 343 is observed visually by the user of the microscope.

The light guided into the binocular unit 332 is directed to the camera unit 331 by the half mirrors 3321 and 3322. The light guided into the camera unit 331 is imaged at a camera imaging surface 3312 via an imaging lens 3311.

The light guided into the binocular unit 332 is also directed to the measurement unit 334 by the half mirror 3321. The light guided into the measurement unit 334 is imaged at an imaging surface 3343 by a reflecting mirror 3341 and an imaging lens 3342. A field of view frame is provided on the imaging surface 3343 so as to guide only light in a predetermined field of view within the imaging surface 3343. Accordingly, the field of view frame in the imaging surface 3343 can be changed (for example, from 100 μm×100 μm to 400 μm×400 μm). The light within the predetermined field of view in the imaging surface 3343 is subsequently made uniform by being mixed or diffused by a light diffusing device 3344 (for example, an optical fiber or an integrating sphere) and is emitted to a multispectral sensor 3346. A replaceable infrared cutting filter 3345 can be placed in front of the multispectral sensor 3346.

The multispectral sensor 3346 is constituted by a plurality of color sensors (for example, 4 to 20 colors). As for the number of color sensors to be used, i.e. the number of spectral measurement channels, the number of channels is increased when the object has highly detailed spectroscopic characteristics and is decreased when high precision measurement is not required, so as to shorten the measurement time. Information on the number of spectral measurement channels is included in the operating conditions determined by the operation condition determining unit 11.

Based on control by the host system 22, the controller 23 synchronizes stage movement instructions provided to the XY driving controller 30 and the Z driving controller 31 and imaging instructions provided to the camera unit controller 24 in order for the above-described microscope system to create a virtual slide. Specifically, the controller 23 causes the camera unit 331 constituting the light detection unit 13 to acquire the specimen image, i.e. the result of inspection, for the specimen 343 at multiple locations while the specimen 343 is moved so as to generate a virtual slide. The above functional blocks constitute a virtual slide generation unit. The host system 22 processes the plurality of partial specimen images acquired by the microscope 32 and generates a virtual slide image. A virtual slide image refers to an image generated by stitching together two or more images taken by the microscope 32, such as an image generated by stitching together a plurality of high-resolution images of portions of the specimen taken by a high power objective lens 342. A virtual slide image is thus a wide-field, high-resolution image of the entire specimen.

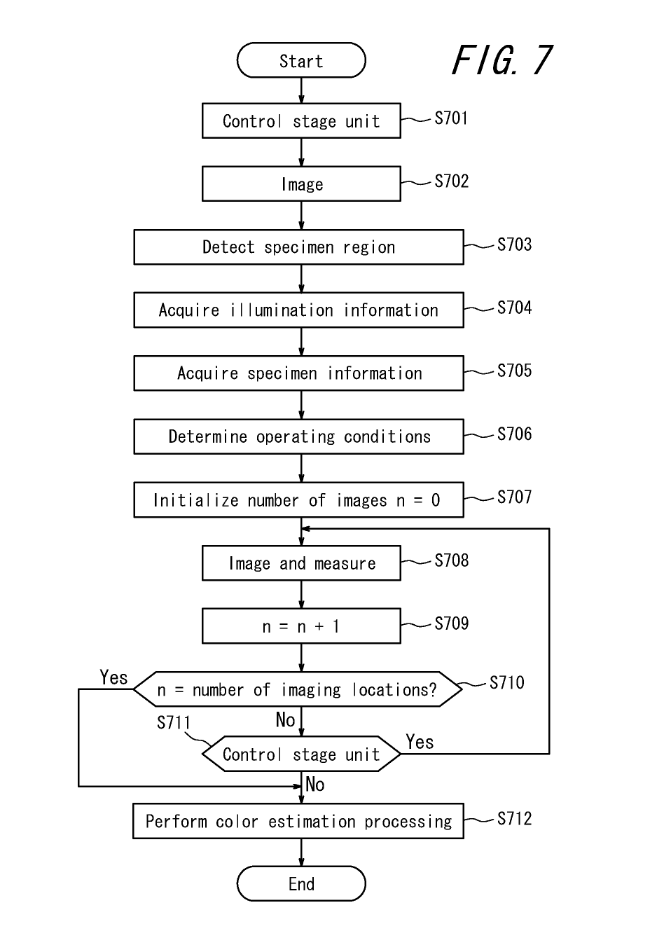

FIG. 7 is a flowchart illustrating schematic operations of the microscope system in FIG. 5. Here, it is assumed that a preparation created from the stained specimen is set in the microscope system and is measured and imaged to generate a virtual slide image. First, the controller 23 controls the Z driving controller 31 and the XY driving controller 30 through the stage unit controller 29 and controls the focus detecting unit 333 through the focus detecting unit controller 26 so as to move the stage unit 344 in order for the low-power objective lens 342 to image the specimen 343 at low power (step S701). Hereinafter, an image taken at low power is referred to as a thumbnail image. Based on the thumbnail image, the host system 22 calculates the imaging locations necessary for generation of a virtual slide image.

The controller 23 controls the camera unit 331 through the camera unit controller 24 to capture an image (step S702). The host system 22 detects the specimen region based on the captured image (step S703). The specimen region is detected based on specimen position information acquired from the thumbnail image. The controller 23 controls the revolver unit 341 through the revolver unit controller 27 to set the high-power objective lens 342 and controls the measurement unit 334 through the measurement unit controller 25 to set the specimen 343 to a position at which one or both of the illumination information and the specimen information can be measured based on the specimen position information acquired from the thumbnail image. The controller 23 then acquires one or both of the illumination information and the specimen information (steps S704 and S705). The host system 22 determines the operating conditions of the measurement unit 334 based on one or both of the acquired illumination information and specimen information (step S706). At this point, the host system 22 determines the operating conditions based on a table of pre-stored illumination information and specimen information or on information that is acquired as needed over a network and includes illumination information and specimen information.

In order to image the specimen 343 at multiple locations, the camera unit controller 24 sets the number of images n to an initial value of zero (step S707). The camera unit 331 images the specimen 343, and the measurement unit 334 measures the specimen 343 in synchronization with imaging (step S708). Upon completion of processing in step S708, the camera unit controller 24 increments the number of images n by one (step S709).

Next, the camera unit controller 24 judges whether the number of images n matches the number of imaging locations calculated by the host system 22 (step S710). If the number of images n does not match the number of imaging locations, the stage unit controller 29 controls the Z driving controller 31 and the XY driving controller 30 (step S711), and processing from step S708 through step S710 is repeated. Conversely, when the number of images n and the number of imaging locations match, the host system 22 performs color estimation processing (step S712) and terminates processing. Specifically, the color estimation processing in step S712 includes specimen spectral estimation, estimation of the dye amount, and specimen image color homogenization and development. Specimen spectral estimation is processing to estimate the spectrum from pixel data. Estimation of the dye amount is processing to estimate the spectrum from pixel data and estimate the dye amount for each stain from the spectrum. The specimen image color homogenization is, for example, smoothing processing using a Gaussian filter, a median filter, an average filter, or the like.

In this way, when generating a virtual slide image of the specimen, the microscope system according to the present embodiment determines the operating conditions of the light detection unit 13 based on illumination information and specimen information before acquiring divided images and can therefore acquire the divided images under optimal conditions. Furthermore, as compared to a device that requires calibration each time the divided images are acquired, the microscope system can shorten the inspection time and quickly generate a virtual slide image.

Whereas the operating conditions of the light detection unit 13 are determined in the present embodiment using both the illumination information and the specimen information, an inspection device according to the present invention may alternatively determine the operating conditions of the light detection unit 13 based on only one of the illumination information and the specimen information. The following describes an example of creating a large-scale virtual slide by determining the operating conditions of a light detection unit based solely on the illumination information.

With the microscope system of the present embodiment, it is possible to create a large-scale virtual slide by automatically changing and imaging a plurality of slides consecutively. When generating a large-scale virtual slide by stitching together images acquired from a plurality of slides, the light source is rarely changed between slides while performing measurement (imaging). It is thus unnecessary to reacquire the illumination information for each slide. Accordingly, in order to generate a large-scale virtual slide, the microscope system is activated and acquires illumination information before measuring the first of a plurality of slides for creating the large-scale virtual slide. As long as no input for changing the illumination information is received, the illumination information need not be acquired for each slide. Since operations for acquiring the illumination information for each of the plurality of slides constituting the large-scale virtual slide are not performed, the time required for creating the large-scale virtual slide can be shortened. While only illumination information is acquired in this example, the specimen information may of course be acquired for each slide or once every certain number of slides.

A variety of modifications and substitutions within the spirit and scope of the present invention will be obvious to a person of ordinary skill in the art. Accordingly, it is to be understood that the present invention is not limited to the above embodiment, and various changes and modifications may be implemented within the scope of the present invention. For example, the microscope device is not limited to the above-described transillumination microscope, but may also be a reflective microscope in which the light detection unit 13 detects illumination light reflected by the specimen (acting on the specimen). A device other than the microscope, such as an inspection device used when manufacturing a semiconductor device, may also be used.

Furthermore, while the above embodiment describes a multispectral sensor that uses dyes, the multispectral sensor may use interference or may use color filters that can control transmitted wavelengths electrically with a liquid crystal tunable filter or the like. In the above embodiment, a selection of the sensor's measurement channels effectively changes the sensitivity characteristics of the entire multispectral sensor. When using color filters that can control the transmitted wavelengths electrically, a similar effect can be achieved by changing the transmission characteristics for the wavelength of each of the sensor's filters electrically. In the above embodiment, channels might not be used during measurement, but with this approach, light can be used more efficiently since filter characteristics can be controlled so that all channels are used. Additionally, two or more of the above-described filters may be used.

### REFERENCE SIGNS LIST

11: Operation condition determining unit
12: Measurement control unit
13: Light detection unit
14: Color estimation unit
21: User interface
22: Host system
23: Controller
24: Camera unit controller
25: Measurement unit controller
26: Focus detecting unit controller
27: Revolver unit controller
28: Light source unit controller
29: Stage unit controller
30: XY driving controller
31: Z driving controller
32: Microscope
33: Lens barrel unit
34: Microscope housing
121: Database
331: Camera unit
332: Binocular unit
333: Focus detecting unit
334: Measurement unit
341: Revolver unit
342: Objective lens
343: Specimen
344: Stage unit
345: Light source unit
3311, 3342: Imaging lens
3312: Camera imaging surface
3321, 3322, 3331: Half mirror
3323: Eyepiece
3332: Focus detecting circuit
3341: Reflecting mirror
3343: Imaging surface
3344: Light diffusing device
3345: Infrared cutting filter
3452: Color conversion filter
3346: Multispectral sensor
3451: Light source
3453: Condenser lens

1. An inspection device for inspecting an object based on illumination light acting on the object, the inspection device comprising:
a light detection unit configured to receive the illumination light acting on the object for inspection and provided with a plurality of photoelectric conversion units with different spectral sensitivity characteristics;
an operating condition determining unit configured to determine operating conditions for the light detection unit;
a measurement control unit configured to control the light detection unit in accordance with the operating conditions; and
a color estimation unit configured to perform color estimation processing based on output from the light detection unit controlled in accordance with the operating conditions, wherein
the operating condition determining unit determines the operating conditions based on at least one of illumination information relating to the illumination light acting on the object for inspection and object information relating to the object for inspection.

2. The inspection device according to claim 1, further comprising a setting storage unit, wherein
the operating condition determining unit is further configured to acquire the illumination information from information stored in the setting storage unit.

3. The inspection device according to claim 1, wherein the operating condition determining unit is further configured to acquire the illumination information by determining a type of illumination based on output of the light detection unit controlled in accordance with predetermined operating conditions.

4. The inspection device according to claim 1, wherein the operating condition determining unit is further configured to acquire the object information by determining a type of the object for inspection based on output of the light detection unit controlled in accordance with predetermined operating conditions.

5. The inspection device according to claim 1, further comprising a virtual slide generation unit configured to generate a virtual slide by moving the light detection unit and the object for inspection relative to each other and acquiring results of inspection at a plurality of locations on the object for inspection.

6. The inspection device according to claim 2, wherein the operating condition determining unit is further configured to acquire the object information based on
output of the light detection unit controlled in accordance with operating conditions based on the acquired illumination information, and
output of the light detection unit controlled in accordance with predetermined operating conditions.

7. The inspection device according to claim 1, wherein the operating condition determining unit includes a read unit and is further configured to acquire the object information by the read unit reading the object information from an external information storage unit.

8. The inspection device according to claim 1, wherein the operating condition determining unit determines the operating conditions by determining at least one of the following: an integration time, a number of integration operations, a time interval between integration operations, and a number of accumulations for output of the light detection unit, and a gain for each of the plurality of photoelectric conversion units in the light detection unit.

9. The inspection device according to claim 1, wherein the operating condition determining unit determines the operating conditions by determining one or more photoelectric conversion units to use among the photoelectric conversion units in the light detection unit.

10. The inspection device according to claim 1, wherein the operating condition determining unit determines the operating conditions by determining that integration operations by the light detection unit are to be performed a plurality of times in order to extend a dynamic range of the light detection unit and by determining a time interval between consecutive integration operations, an integration time for the output from the light detection unit upon each integration operation, and a gain for each of the plurality of photoelectric conversion units.

11. The inspection device according to claim 1, wherein the color estimation unit performs the color estimation processing by performing at least one of detailed identification and spectral estimation of a color of the object for inspection.
